(19) United States
(12) Patent Application Publication
(10) Pub. No.: US 2011/0181500 A1
(43) Pub. Date: Jul. 28, 2011

(54) LUMINANCE COMPENSATION APPARATUS FOR AN OLED PANEL AND METHOD THEREOF

(75) Inventor: Chih-Yang Liao, Tainan County (TW)

(73) Assignee: HIMAX TECHNOLOGIES LIMTED, Tainan County (TW)

(21) Appl. No.: 12/695,465

(22) Filed: Jan. 28, 2010

(51) Int. Cl. G09G 3/30

(52) U.S. Cl. 345/76

(57) ABSTRACT

A luminance compensation apparatus for an OLED panel including a luminance integration unit and a luminance compensation unit is provided. The luminance integration unit is used for respectively integrating a luminance value for each dot of an OLED panel before a current frame period to obtain an integrated luminance value for each dot of the OLED panel. The luminance compensation unit is used for respectively converting the integrated luminance value for each dot of the OLED panel to a compensation luminance value for each dot of the OLED panel according to a compensation lookup table, and generating an output luminance value for each dot of the OLED panel according to the compensation for luminance value for each dot of the OLED panel and a luminance value for each dot of the OLED panel at the current frame period to drive signals to compensate luminance for each dot of the OLED panel.

### FIELD OF THE INVENTION

The present invention described herein relates generally to luminance compensation and more particularly to a luminance compensation apparatus for an OLED panel and method thereof.

### DESCRIPTION OF THE RELATED ART

An OLED panel comprises a plurality of pixels therein. Each pixel of an OLED panel is made up of three dots (or sub-pixels) which represent three main colors red, green and blue (R, G, and B) respectively. Each dot is driven to a specified luminance value at different times and held for different time periods. Thus, power consumption for each dot is different. Generally the specified luminance value reached by dots will decay over time. Thus, the luminance radiated by each dot in an OLED panel becomes more and more non-uniform as time passes. Accordingly, conventionally, a sensor is used to detect luminance decay for each dot, wherein luminance radiated by each dot is compensated for by adjusting respective driving voltage or current thereof. Thus ensuring uniform luminance of OLED panels. However, sensor requirements increase costs of the OLED panel.

Thus, a new apparatus and method for luminance compensation for an OLED panel is called for.

### BRIEF SUMMARY OF INVENTION

A detailed description is given in the following embodiments with reference to the accompanying drawings.

In one aspect, the present invention provides a luminance compensation apparatus for an OLED panel. The luminance compensation apparatus for an OLED panel includes a luminance integration unit and a luminance compensation unit. The luminance integration unit is used for respectively integrating a luminance value for each dot of an OLED panel before the current frame period to obtain an integrated luminance value for each dot of the OLED panel. The luminance compensation unit is used for respectively converting the integrated luminance value for each dot of the OLED panel to a compensation luminance value for each dot of the OLED panel according to a compensation lookup table, and generating a output luminance value for each dot of the OLED panel according to the compensation for luminance value for each dot of the OLED panel and a luminance value for each dot of the OLED panel at the current frame period to drive signals to compensate luminance for each dot of the OLED panel. The luminance compensation unit further includes an addition unit. The addition unit is used for respectively adding the compensation luminance value for each dot of the OLED panel to the luminance value for each dot of the OLED at the current frame period to obtain the output luminance value for each dot of the OLED panel.

In another aspect, the present invention provides a luminance compensation method for an OLED panel. The method includes the steps of: providing a luminance value for each dot of the OLED panel for each frame to a luminance compensation apparatus before a current frame period; integrating the luminance value respectively for each dot of the OLED panel before the current frame period by a luminance integration unit of the luminance compensation apparatus to obtain an integrated luminance value for each dot of the OLED panel; converting the integrated luminance value for each dot of the OLED panel to a compensation luminance value for each dot of the OLED panel by a luminance compensation unit of the luminance compensation apparatus; generating an output luminance value for each dot of the OLED panel from the luminance compensation apparatus according to the compensation luminance value for each dot of the OLED panel and a luminance value for each dot of the OLED panel at the current frame period; and driving the OLED panel by the luminance compensation apparatus to compensate for luminance for each dot of the OLED panel according to the output luminance value for each dot of the OLED panel; wherein the generating the output luminance value comprises: adding the compensation luminance value for each dot of the OLED panel and the luminance value for each dot of the OLED panel at the current frame period by an adder of the luminance compensation apparatus to obtain an output luminance value for each dot.

The above-mentioned luminance compensation apparatus for an OLED panel and method thereof employs a lookup table for a compensation reference so that sensor is not required and costs may be lowered.

### BRIEF DESCRIPTION OF DRAWINGS

The present invention can be more fully understood by reading the subsequent detailed description and examples with references made to the accompanying drawings, wherein:

FIG. 1 is a block diagram showing the structure of a luminance compensation apparatus for an OLED panel of the present invention;

FIG. 2 is a block diagram showing the structure of a luminance integration unit of the luminance compensation apparatus of FIG. 1 of the present invention;

FIG. 3 is an exemplary lookup table of the luminance compensation apparatus block according to the embodiment of the present invention;

FIG. 4A is a diagram showing the relationship between the integrated luminance value and the compensation luminance value;

FIG. 4B is a diagram showing the relationship between the power consumption value and the luminance value;

FIG. 4C is a diagram showing the relationship between the integrated luminance value and the power consumption value;

FIG. 4D is a diagram showing the relationship between the integrated luminance value and the luminance value;

FIG. 5 is another exemplary lookup table of the luminance compensation apparatus according to the embodiment of the present invention;

FIG. 6 is an exemplary block diagram detailing the structure of the luminance compensation apparatus of FIG. 1 of the present invention;

FIG. 7A is a flowchart illustrating a luminance compensation method for an OLED panel according to an embodiment of the present invention;

FIG. 7B is a flowchart illustrating a method to integrate a luminance value of a dot in the luminance compensation method for an OLED panel according to an embodiment of the present invention; and

FIG. 7C is a flowchart illustrating a procedure for permanently storing an integrated luminance value of a dot in the luminance compensation method for an OLED panel.

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

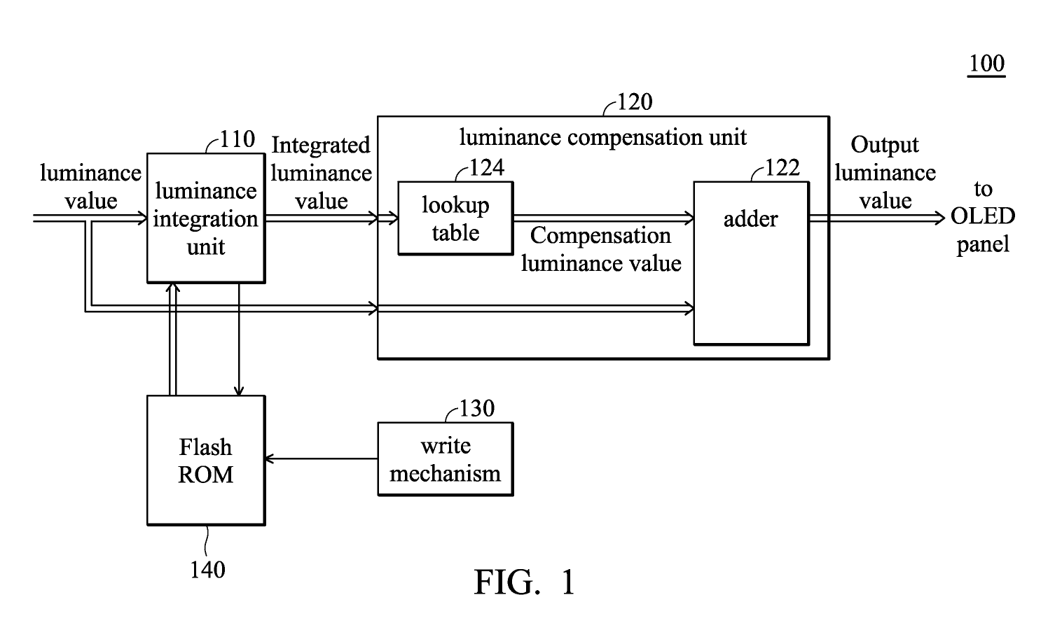

FIG. 1 is a block diagram showing the structure of a luminance compensation apparatus for an OLED panel of the present invention. The luminance compensation apparatus 100 for the OLED includes a luminance integration unit 110, a luminance compensation unit 120, a write mechanism 130 and a Flash ROM 140.

The luminance integration unit 110 may respectively integrate a luminance value for each dot of the OLED panel before the current frame period to obtain an integrated luminance value for each dot of the OLED panel. The luminance value of each dot, regardless of color red, green or blue, may be integrated by accumulating the luminance value of each dot from a starting frame period to the current frame period. In one embodiment, the luminance compensation unit 120 further includes an adder 122 and a compensation lookup table 124. The luminance compensation unit 120 may respectively convert the integrated luminance value for each dot of the OLED panel to a compensation luminance value for each dot of the OLED panel according to the compensation lookup table 124. Then the adder 122 may add the compensation luminance value for each dot of the OLED panel to the luminance value for each dot of the OLED at the current frame period to generate an output luminance value for each dot of the OLED panel. The output luminance value is delivered to the OLED as a driving reference value which used to compensate for luminance for each dot of the OLED panel. In another embodiment, the lookup table 124 and the adder 122 may be combined to form another independent lookup table.

The Flash ROM 140 may store the integrated luminance value for each dot of the OLED panel. The write mechanism 130 may send a first write signal to a Flash ROM 140 during a shutdown time before the luminance compensation apparatus is power off. The luminance integration unit 110 may also send a second write signal to the Flash ROM 140 while the luminance value is read during the shutdown time. The luminance value for each dot of the OLED panel may be written into the Flash ROM while both the first write signal and the second write signal are being enabled. That is, the Flash ROM may only have one short time period to store the integrated luminance value when reading the integrated luminance for each dot of the OLED panel before the luminance compensation apparatus is powered off.

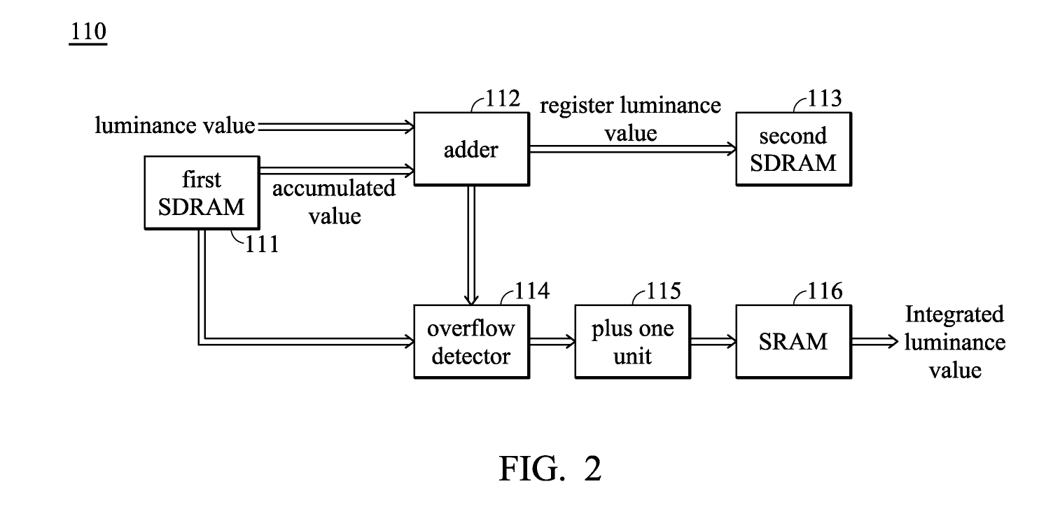

FIG. 2 is a block diagram showing the structure of a luminance integration unit of the luminance compensation apparatus of FIG. 1 of the present invention. The luminance integration unit 110 includes a first SDRAM 111, an adder 112, a second SDRAM 113, an overflow detector 114, a plus one unit 115, and an SRAM 116.

The first SDRAM 111 may temporarily store an accumulated value for each dot of the OLED panel before the current frame period. The accumulated value is empty at an initial frame period. An adder 112 may add the luminance value for each dot of the OLED panel to the accumulated value in the first SDRAM at every frame period. The summed value of the adder 112, a register luminance value for each dot of the OLED panel, is sent to a second SDRAM 113 for temporarily storage. Due to SDRAM characteristic, the same data in the SDRAM can not be maintained for a long period of time. The register luminance value in the second SDRAM 113 may be transferred to the first SDRAM 111 as a new accumulated value for each dot of the OLED before the next frame period. At next frame period, the accumulated value for each dot of the OLED panel may be added to the luminance value for each dot of the OLED panel to result in a new register luminance value for each dot of the OLED.

The overflow detector 114 may detect overflow status of the adder 112 and the first SRAM 111 according to the register luminance value for each dot of the OLED panel from the adder 112 or the accumulated value from the first SDRAM 111. When the adder 112 is overflowed, the overflow detector will inform the plus one unit to generate a plus one value responding to a specified dot. In some cases, the register luminance value for some dots may not be overflowed, so there would not be a plus one value. The plus one value for each dot of the OLED panel will be sent to the SRAM 116 for accumulation. The plus one value for each dot of the OLED panel which is accumulated in the SRAM is the integrated luminance value for each dot of the OLED panel. In some cases, the integrated luminance value may be zero. A detailed description of the relationship between the integrated luminance value and the compensation luminance value will be described below.

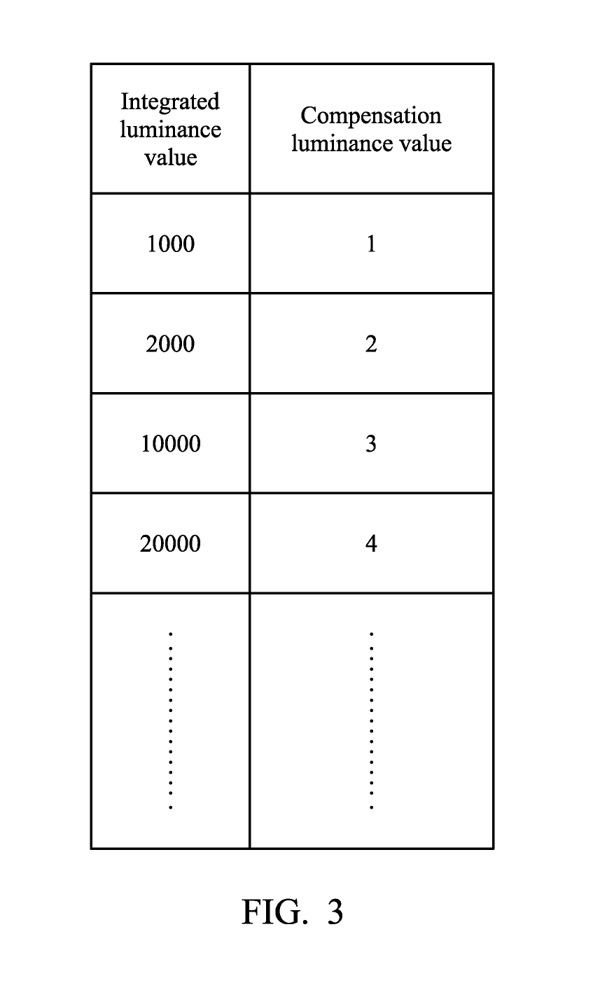

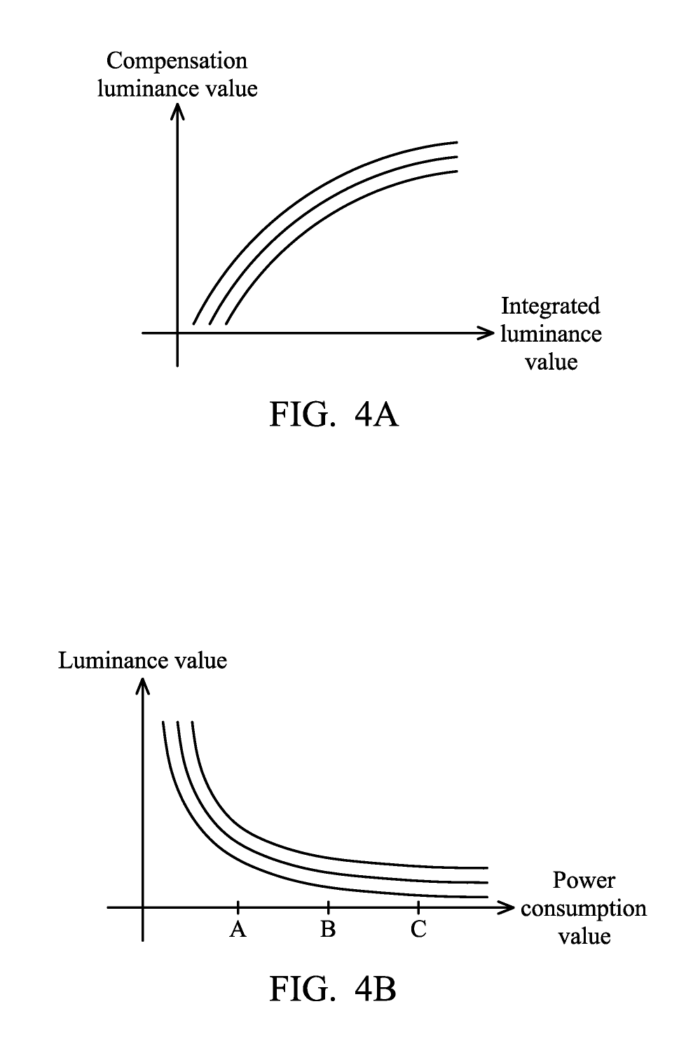

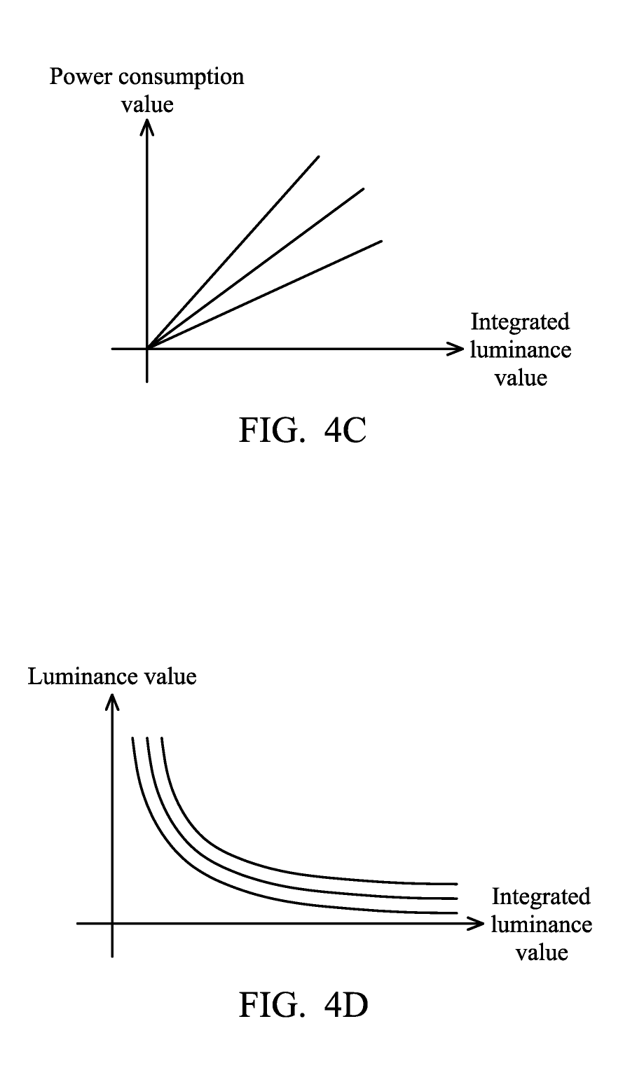

FIG. 3 is an exemplary lookup table of the luminance compensation apparatus block according to the embodiment of the present invention. The values in the lookup table are exemplary numbers. The lookup table is created according to a non-linear relationship between the integrated luminance value and the compensation luminance value, as shown in FIG. 4A. In one embodiment, the non-linear relationship of the curve is derived from a power to luminance measurement, a ratio between an integrated luminance value and a power consumption value, and a compensation formula.

A measured relationship between the power consumption value of a dot and the luminance value of the dot is shown in FIG. 4B according to an optical characteristic experiment. When the power consumption of the dot increases, luminance of the dot decreases. Also, power consumption of the dot is positively proportional to the integrated luminance value of the dot as shown in FIG. 4C. Therefore, FIG. 4D shows the relationship between the integrated luminance value of the dot and luminance value of the dot. Theoretically, the luminance value and the compensation luminance value are complementary, and the greater the power consumption value of a dot is, the greater the compensation luminance value is. The compensation formula is therefore built according to the two conditions.

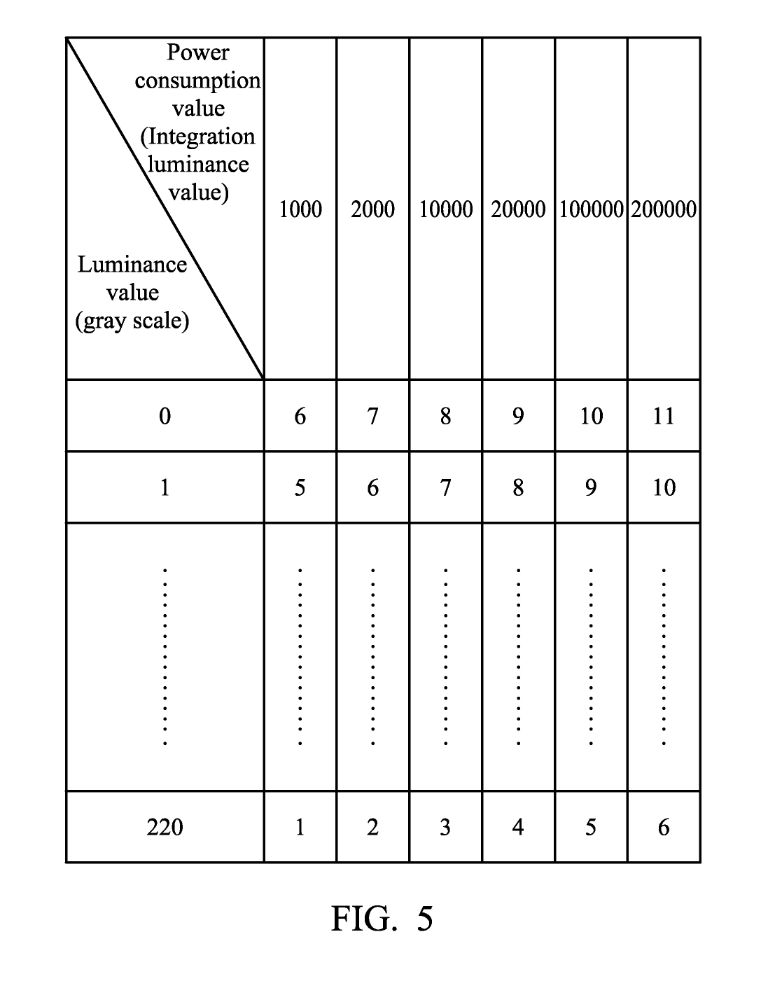

FIG. 5 is another exemplary lookup table of the luminance compensation apparatus according to the embodiment of the present invention. The values in the lookup table are exemplary numbers. The lookup table is created according to a non-linear relationship between the integrated luminance value and the compensation luminance value as shown in FIG. 4A, and the luminance value (or gray scale) for each dot of an OLED panel at a current frame period. The gray scale corresponds to the luminance value, i.e. the gray scale and the luminance value both can be converted to with each other. It is can be easily understood that the luminance compensation unit 120 is another type of lookup table which combines the lookup table 124 with the adder 122.

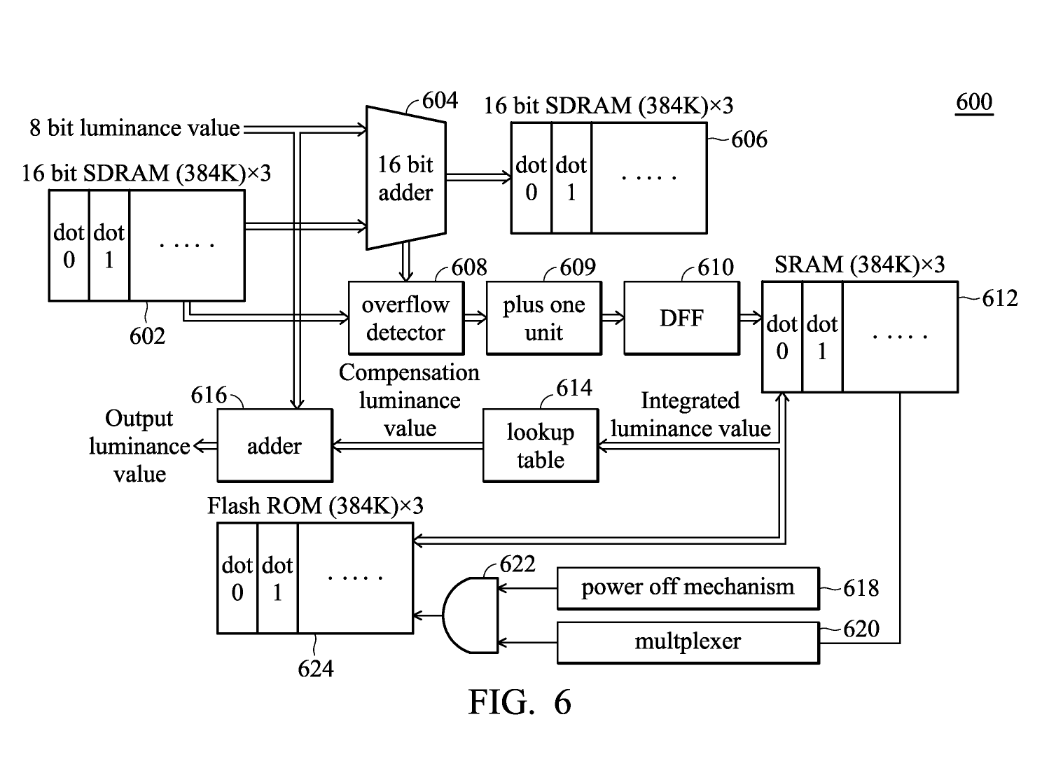

FIG. 6 is an exemplary block diagram detailing the structure of the luminance compensation apparatus of FIG. 1 of the present invention. The luminance compensation apparatus includes a first adder 604 with a 16 bit width, three first 16-bit SDRAMs 602 with 384K-byte capacity respectively, three second 16-bit SDRAMs 606 with 384K-byte capacity respectively, an overflow detector 608, a plus one unit 609, a D type Flip-Flop 610, three 16-bit SRAMs 612 with 384K-byte capacity respectively, three lookup tables 614, a second adder 616, a power off mechanism 618, a multiplexer 620, and a two-input AND gate 622 and three 16-bit Flash ROMs 624 with 384K-byte capacity respectively.

In an embodiment of the present invention, each type of storage has three memory devices with identical capacity which respectively store each dot luminance value for a red color, a green color, and a blue color. Additionally, there are three lookup tables 614, and three second adder 616 which are respectively operated corresponding to the three main colors. Because same device types have same functions, the diagram only shows a block for the purpose of simplicity.

At an initially starting frame period, the 16-bit SDRAMs 602 are all empty. Next, an 8-bit luminance value of a dot such as dot 0 of red color is provided. The luminance value of the red colored dot and an accumulated value of the dot which is zero at current frame period in the first SDRAM 602 of red color are added together by the first adder 604 to obtain a register luminance value of the red colored dot. In one embodiment, only the 4 high bits of the luminance value are sent to the first adder 604 for addition, but the invention is not limited thereto. The register luminance value of the red colored dot is stored in the second SDRAM 606 of the red colored, and the register luminance value of the red colored dot is transferred to the first SDRAM 602 as a new accumulated value of the red colored dot before the next frame period. In the second frame period, another luminance value of the red colored dot and the new accumulated value of the red colored dot are added to obtain a new register luminance value of the red colored dot. The new luminance value of the red colored dot which replaces the previous luminance value of the red colored dot is also stored in the second SDRAM 606 of the red colored dot, and the new register luminance value of the red colored dot is also transferred to the first SDRAM of the red colored dot as a new accumulated value of the red colored dot before the next frame period, and so on. When the summed value of the adder 604 is overflowed, the overflow detector 608 will check the overflow status and inform the plus one unit 609 to generate a plus one value to the SRAM 612 of red color through the D type Flip-Flop 610 latch. The plus one value is accumulated and stored in the SRAM 612 of red color. The accumulated plus one value is the integrated luminance value of the red colored dot.

The integrated luminance value of the dot is then input to the lookup table 614 for the red color for conversion. After conversion, the compensation luminance value is produced and is added to the luminance value of the red colored dot at the current frame period to generate the output luminance value. The integrated luminance value of the red colored dot may be saved in the Flash ROM before the luminance compensation apparatus 600 is powered off. The power off mechanism 618 is operative to output a first write signal to one input terminal of the two-input AND gate 622 during a shutdown time before the luminance compensation apparatus 600 is powered off. When the Flash ROM 624 of red color reads the SRAM 612, that SRAM 612 will output an asserted signal to the multiplexer 620. The multiplexer 620 selects asserted signal as a second write signal which is sent to the other input terminal of the two-input AND gate 622. Therefore, the Flash ROM 384 reads out and stores the integrated luminance value of the red colored dot when the first signal and the second signal are both enabled to enable the output signal of the two-input AND gate 622. In one embodiment, there is only a short time for the power off mechanism 618 to respectively generate three first write signals. The short time will at least be a clock-period*384K*3. During the short time, all the SRAMs will stop being written to with new data, or read out by other devices except for the Flash ROMs 624. Besides, when the luminance compensation apparatus 600 is powered on, the Flash ROM 624 of red color will load or write previously stored data into the SRAM 612. The above procedure is executed by each dot of each color. In another embodiment, the lookup table 614 and the second adder 616 may be combined to form another type of lookup table.

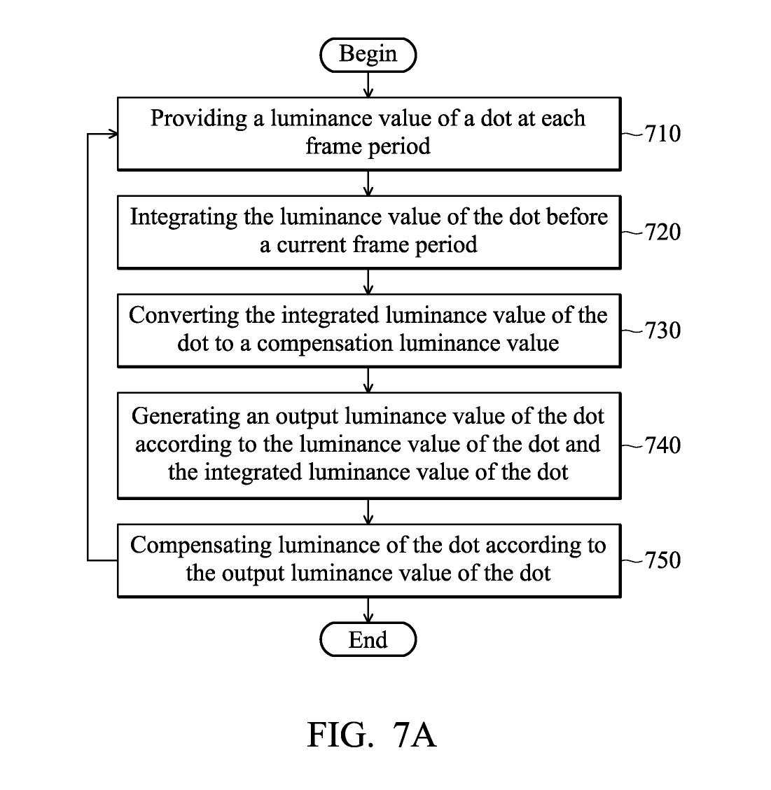

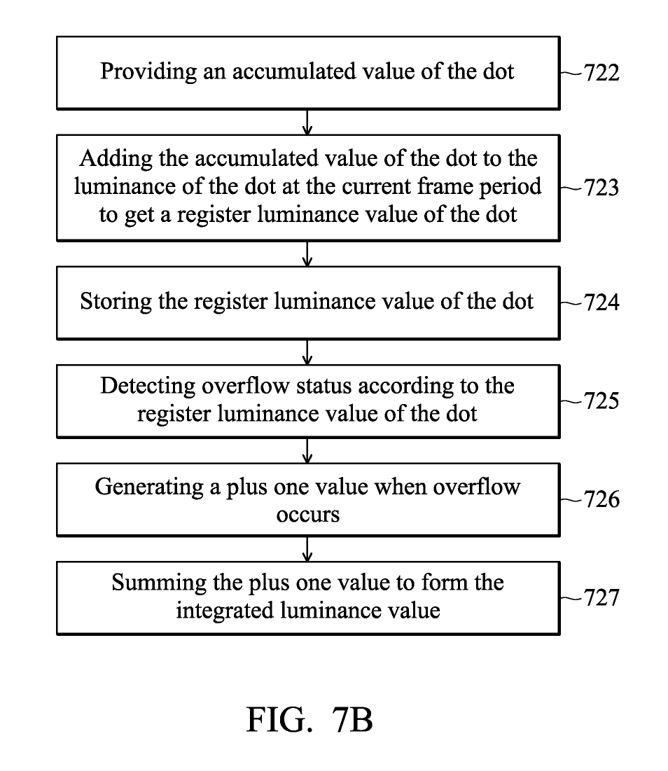

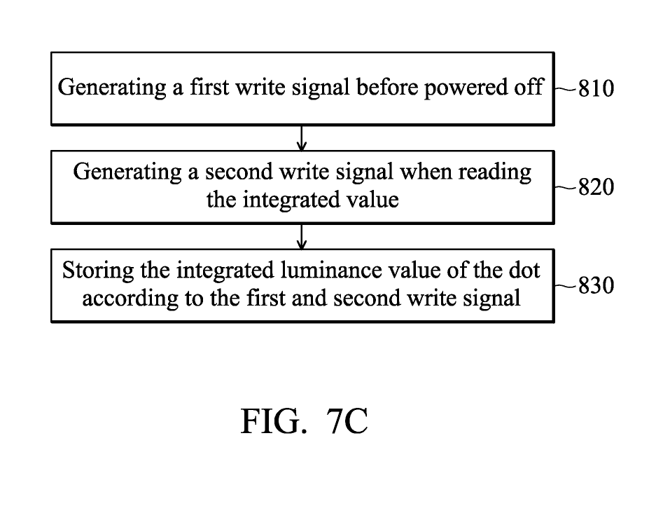

FIG. 7A is a flowchart illustrating a luminance compensation method for an OLED panel according to an embodiment of the present invention. In the embodiment, each dot of an OLED panel would be executed with the luminance compensation method. However, for simplicity, one dot is taken as an example for description herein. At step 710, a luminance value of a dot is provided to the luminance compensation apparatus at each frame period. Then the luminance compensation apparatus integrates the luminance value of the dot before the current frame period at step 720 by summing the luminance value of the dot at each frame period.

The mechanism to integrate the luminance value of the dot is shown in steps 722-727 of FIG. 7B. First, an accumulated value of the dot is provided (step 722). The accumulated value of the dot is the summation of the luminance value of the dot for each frame period. At the starting period, the accumulated value of the dot is zero. At each frame period the accumulated value of the dot is added to the luminance value of the dot by an adder to get a register luminance value of the dot (step 723). Before the next frame period, the register luminance value of the dot will be transferred to as a new accumulated value of the dot. At the next frame period, the new accumulated value of the dot may be added to the luminance value of the dot and so on. In the embodiment, there are two SDRAMs, a first SDRAM and a second SDRAM, respectively storing the accumulated value of the dot and the register luminance value of the dot (step 724). Next, an overflow status will be detected by an overflow detector according to the register luminance value from the adder (step 725). When overflow status occurs, the plus one value will be generated by a plus one unit (step 726). Finally, the plus one value is summed as the integrated luminance of the dot and temporarily stored in a SRAM (step 727).

In the embodiment, there is a mechanism used for permanently storing the integrated luminance value of the dot. The integrated luminance value of the dot may be saved to a Flash ROM before the luminance compensation apparatus is powered off. The procedure is shown in steps 810-830 of FIG. 7C. A first write signal is generated by a power off mechanism during a shutdown time (step 810). A second write signal is generated from the SRAM while the Flash ROM reads the integrated luminance value of the dot in the SRAM (step 820). The integrated luminance value of the dot may be stored when the two write signal are both enabled (step 830).

At step 730, the integrated luminance value of the dot is converted to a compensation luminance value of the dot according to a lookup table according to a compensation formula. Afterward the compensation luminance value of the dot is added to the integrated luminance of the dot at a current frame period to generate an output luminance value of the dot at step 740. In one embodiment, the step 730 and the step 740 may be combined together. The integrated luminance value of the dot may be directly converted to the output luminance value of the dot according to a lookup table further referring the luminance value of the dot. Finally, the luminance of the dot is compensated for by the luminance compensation apparatus driving the OLED panel according to the output luminance value of the dot at step 750.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A luminance compensation apparatus for an OLED panel, comprising:
a luminance integration unit for respectively integrating a luminance value for each dot of an OLED panel before a current frame period to obtain an integrated luminance value for each dot of the OLED panel; and
a luminance compensation unit for respectively converting the integrated luminance value for each dot of the OLED panel to a compensation luminance value for each dot of the OLED panel according to a compensation lookup table, and generating an output luminance value for each dot of the OLED panel according to the compensation luminance value for each dot of the OLED panel and a luminance value for each dot of the OLED panel at the current frame period to drive signals to compensate for luminance for each dot of the OLED panel;
wherein the luminance compensation unit comprises an addition unit for respectively adding the compensation luminance value for each dot of the OLED panel to the luminance value for each dot of the OLED at the current frame period to obtain the output luminance value for each dot of the OLED panel.

2. The luminance compensation apparatus as claimed in claim 1, further comprising:
a write mechanism for sending a first write signal during a shutdown time before the luminance compensation is powered off;
a Flash ROM for storing the integrated luminance value for each dot of the OLED panel according to the first write signal and a second write signal from the luminance integration unit when reading the integrated luminance value for each dot of the OLED panel.

3. The luminance compensation apparatus as claimed in claim 2, wherein the integrated luminance value for each dot of the OLED panel in the Flash ROM is up-loaded into the luminance integration unit when the luminance compensation apparatus is powered on.

4. The luminance compensation apparatus as claimed in claim 1, wherein the luminance integration unit comprises:
a first SDRAM for storing an accumulated value for each dot of the OLED panel before the current frame period;
an adder for adding the luminance value for each dot of the OLED panel at the current frame period to the accumulated value in the first SDRAM to obtain a register luminance value for each dot of the OLED panel;
a second SDRAM for storing the register luminance value for each dot of the OLED panel;
an overflow detector for detecting overflow status of the adder according to the register luminance value for each dot of the OLED panel in the adder;
a plus one unit for generating a plus one value responding to a specified dot when the adder's status is overflowed;
an SRAM for accumulating the plus one value for each dot of the OLED panel to generate the integrated luminance value for each dot of the OLED panel, and storing the integrated luminance value.
wherein the register luminance value for each dot of the OLED panel in the second SDRAM is transferred to the first SDRAM as a new accumulated value for each dot of the OLED panel before the next frame period.

5. The luminance compensation apparatus as claimed in claim 1, wherein the compensation lookup table comprises:
a power to consumption process for converting the integrated luminance value for each dot of the OLED panel to a power consumption value for each dot of the OLED panel with a linear proportion;
a luminance process for converting the power consumption value for each dot of the OLED panel to the compensation luminance value for each dot of the OLED panel according to a power to luminance measurement and a compensation formula.

6. A luminance compensation method for an OLED panel, comprising:
providing a luminance value for each dot of the OLED panel for each frame to a luminance compensation apparatus before a current frame period;
integrating the luminance value respectively for each dot of the OLED panel before the current frame period by a luminance integration unit of the luminance compensation apparatus to obtain an integrated luminance value for each dot of the OLED panel;
converting the integrated luminance value for each dot of the OLED panel to a compensation luminance value for each dot of the OLED panel by a luminance compensation unit of the luminance compensation apparatus;
generating an output luminance value for each dot of the OLED panel from the luminance compensation apparatus according to the compensation luminance value for each dot of the OLED panel and a luminance value for each dot of the OLED panel at the current frame period; and
driving the OLED panel by the luminance compensation apparatus to compensate for luminance for each dot of the OLED panel according to the output luminance value for each dot of the OLED panel;
wherein the generating the output luminance value comprises:
adding the compensation luminance value for each dot of the OLED panel and the luminance value for each dot of the OLED panel at the current frame period by an adder of the luminance compensation apparatus to obtain an output luminance value for each dot.

7. The luminance compensation method as claimed in claim 6, further comprising:
generating a first write signal from a power off mechanism of the luminance compensation apparatus before the apparatus is powered off;
generating a second write signal from an SRAM of the luminance compensation apparatus when reading the integrated luminance value in the SRAM;
storing the integrated luminance value for each dot of the OLED panel into a Flash ROM of the luminance compensation apparatus according to the first write signal and the second write signal.

8. The method as claimed in claim 7, further comprising uploading the integrated luminance value from the Flash ROM to the SRAM for each dot of the OLED panel when powered on.

9. The method as claimed in claim 6, wherein the integrating the luminance value for each dot for each frame comprises:
providing an accumulated value from a first SDRAM of the luminance compensation apparatus for each dot of the OLED panel before the current frame period;
adding the luminance value for each dot of the OLED panel at the current frame period to the accumulated value for each dot of the OLED panel in the first SDRAM before the current frame period to obtain a register luminance value for each dot of the OLED panel;
storing the register luminance value into the second SDRAM of the luminance compensation apparatus for each dot of the OLED panel temporarily;
detecting overflow status by a overflow detector in the luminance compensation apparatus according to the register luminance value for each dot of the OLED panel;
generating a plus one value by a plus one unit of the luminance compensation apparatus responding to a specified dot when overflow status is detected; and
accumulating the plus one value for each dot of the OLED panel as the integrated luminance value for each dot of the OLED panel and storing the integrated luminance value for each dot of the OLED panel into the SRAM.

10. The method as claimed in claim 6, wherein the conversing the integrated luminance value for each dot of the OLED panel comprises:
converting the integrated luminance value for each dot to a power consumption value for each dot of the OLED panel with a linear proportion;
converting the power consumption value for each dot of the OLED panel to the compensation luminance value for each dot of the OLED panel according to a power to luminance measurement and a compensation formula.
